(19) United States
(12) Patent Application Publication
(10) Pub. No.: US 2026/0278134 A1
(43) Pub. Date: Sep. 17, 2026

(54) Attribute Authority Delegation In Data Storage Environments

(71) Applicant: NetApp, Inc., San Jose, CA (US)

(72) Inventors: Richard Parvin Jernigan, IV, El Paso, TX (US); Derek John Bendixen, Broomfield, CO (US); Umeshkumar Vasantha Rajasekaran, Cranberry Township, PA (US)

(73) Assignee: NetApp, Inc., San Jose, CA (US)

(21) Appl. No.: 19/280,687

(22) Filed: Jul. 25, 2025

Related U.S. Application Data
(60) Provisional application No. 63/769,822, filed on Mar. 11, 2025.

(51) Int. Cl. G06F 21/62

(52) U.S. Cl. CPC G06F 21/6218

(57) ABSTRACT

The disclosure describes systems, devices, and methods for managing multi-part files and attributes thereof in data storage environments. In an example implementation, a method of operating multiple storage controllers in a data storage environment is provided. In performing the method, a data element of a storage controller of the multiple storage controllers receives an input/output request from a network element of a one of the multiple storage controllers corresponding to data to a multi-part file stored across multiple storage devices in the data storage environment. The input/output request includes current attributes of the multi-part file. The data element executes the input/output request with respect to a part of the multi-part file corresponding to the storage controller and determines whether to delegate attribute authority to the network element based on a set of criteria.

### RELATED APPLICATIONS

This application hereby claims the benefit and priority to U.S. Provisional Patent Application No. 63/769,822, titled “ATTRIBUTE AUTHORITY DELEGATION,” filed Mar. 11, 2025, which is hereby incorporated by reference in its entirety.

### TECHNICAL FIELD

Embodiments of the present disclosure relate generally to data storage technology, and in particular, to managing multi-part files in a data storage environment.

### BACKGROUND

A data storage environment may employ a file system to provide data storage and management capabilities for users and organizations. A file system may include several controllers and an aggregate of storage devices accessible by the controllers. Users in communication with the file system can request storage of files and access to the files. To enable such functionality, each controller employs storage operating software to perform operations at the storage devices. For example, in performing an operation to write data to a file stored by the file system, a controller is invoked to write the data to a particular location on one or more of the storage devices in accordance with the file system protocol.

For large files, such as files in the terabyte range, the file system may distribute chunks of the files among the storage devices. These files may be referred to as multi-part files. The file system can utilize multiple controllers with which to manage input/output to a multi-part file, where each controller owns a chunk of the multi-part file. When a controller performs a write for a respective part of the file, the controller updates properties, or attributes, of the file to indicate information such as the last time the file was modified by the controller and the length of the file. Problematically, since each controller only owns a part of the file, the attributes of the file, from the perspective of one controller, may differ from the attributes of the file from the perspective of another controller. Additionally, the controllers might not know the attributes of the file as a whole.

An existing solution to managing attributes of a multi-part file uses a centralized controller to compile the attributes managed by each controller that owns a part of the file. The centralized controller can communicate with each controller to determine attributes for the individual parts of the file, then consolidate the attributes into an overall view of the file. However, this process is time-consuming and processing intensive as clients may request attributes for the file after each write request. Under such circumstances, the centralized controller may bottleneck the I/O operations as the centralized controller attempts to keep up with all of the changing attributes, causing latency and inefficiencies.

### SUMMARY

The technology described herein improves the management of multi-part files and attributes thereof in data storage environments. In an example implementation, a method of operating multiple storage controllers in a data storage environment is provided. In performing the method, a data element of a storage controller of the multiple storage controllers receives an input/output request from a network element of a one of the multiple storage controllers corresponding to data of a multi-part file stored across multiple storage devices in the data storage environment. The input/output request includes current attributes of the multi-part file. The data element executes the input/output request with respect to a part of the multi-part file corresponding to the storage controller and determines whether to delegate attribute authority to the network element based on a set of criteria.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter. These and other features and aspects of various examples may be understood in view of the following detailed discussion and accompanying drawings.

### BRIEF DESCRIPTION OF THE DRAWINGS

For a more complete understanding of the present invention(s), and the advantages thereof, reference is now made to the following descriptions taken in conjunction with the accompanying drawings.

FIG. 1 illustrates an example data storage system in an implementation.

FIG. 2 illustrates a method for managing storage controllers of a data storage system in an implementation.

FIG. 3 illustrates an example operational sequence performed by storage controllers of a data storage system in an implementation.

FIG. 4 illustrates an example controller suitable for implementing the various systems, operational environments, architectures, environments, methods, processes, scenarios, sequences, and frameworks discussed below with respect to the other Figures.

FIGS. 5A, 5B, and 5C illustrate example operating environments in which multi-part file and attribute management operations may be performed in an implementation.

FIG. 6 illustrates a computing system suitable for implementing the various systems, operational environments, architectures, environments, methods, processes, scenarios, sequences, and frameworks discussed below with respect to the other Figures.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION

Various embodiments of the technology disclosed herein mitigate the problems discussed above with respect to the management of multi-part files, and in particular, to the management of attributes of multi-part files stored in data storage environments. Several embodiments of the present technology relate to data storage environments that include multiple controllers (or nodes) and a storage aggregate including multiple storage devices. The controllers in a data storage environment may implement a file system using a storage operating system (e.g., NetApp ONTAP® (without derogation of trademark rights of NetApp Inc., the assignee of this application)) that provides enterprises and users with file management and data storage solutions across various environments including on-premises, hybrid cloud, and multi-cloud deployments.

A user can request storage of files, open files, and edit files, all of which is managed by the controllers in the data storage environment. In the background, the file system tracks where the file is stored, as well as various properties and metadata related to the file, which may be collectively referred to as “attributes.” Upon a request to read a file, the file system identifies where the file is stored, retrieves the file, and provides the file to a user. The user need not be concerned with where or how the file is stored as the storage and management is handled by the file system.

The file system can offer storage for large files even in the terabyte or petabyte range and greater by using file distribution and load balancing techniques to store files in multiple parts across several controllers and storage devices accessible by the controllers. For example, for some files that are too large to be stored in a single storage device, the file system may employ granular data distribution (GDD) to create a multi-part file. In various embodiments, a multi-part file created by a GDD feature refers to a file that the file system stores using multiple index nodes (“inodes”) (e.g., a data structure holding metadata about a file or directory) via a write anywhere file layout (WAFL) architecture.

With respect to the file system more generally, each controller implements a file system (e.g., WAFL) that logically organizes stored information as a hierarchical structure for files/directories/objects at the storage devices. Each “on-disk” file can be implemented as a set of data blocks configured to store information, such as text, whereas a directory can be implemented as a specially formatted file in which other files and directories are stored. The data blocks are organized within a volume block number (VBN) space that is maintained by the file system. The file system may also assign each data block in the file a corresponding “file offset” or file block number (FBN). The file system typically assigns sequences of FBNs on a per-file basis, whereas VBNs are assigned over a larger volume address space. The file system organizes the data blocks within the VBN space as a logical volume. The file system typically may include a contiguous range of VBNs from zero to n, for a file system of size n−1 blocks. When accessing a block of a file in response to an input/output request, the file system specifies a VBN that is translated at the file system/RAID system boundary into a physical volume block number (“PVBN”) location on a particular storage device (storage device, PVBN) within a RAID group of the physical volume).

The file system maintains a buffer tree as an internal representation of blocks for a file stored in a buffer cache of a memory of a controller. Broadly stated, the buffer tree has an inode at the root (top-level) of the file. An inode is a data structure used to store information, such as metadata, about a file, whereas the data blocks are structures used to store the actual data for the file. The information in an inode may include, e.g., ownership of the file, file modification time, access permission for the file, size of the file, file type and references to locations on storage devices of the data blocks for the file. The references to the locations of the file data are provided by pointers, which may further reference indirect blocks that, in turn, reference the data blocks, depending upon the amount of data in the file. Each pointer can be embodied as a VBN to facilitate efficiency among the file system and the RAID system when accessing the data.

By way of example, for an implementation involving a multi-part file split into three parts, three inodes store information about their own understanding of their part's size, and the times at which their part was most recently read, written, or had its properties changed, these attributes being referred to as “atime,” “mtime,” and “ctime,” respectively. The inodes that support a multi-part file might be drawn from many different storage volumes and might be served by many different data elements (e.g., data blades (or D-blades), e.g., a storage access layer of a controller) in a storage cluster including multiple nodes functioning together as a unified storage system.

Additionally, another inode referred to as a catalog inode stores a collection of the information stored in the other three inodes informing the file system where to find the three parts of the file (e.g., the location of the three inodes and their contents). In some ways, this catalog represents the collective file, as well as the catalog's identity that is exposed to the client/user as the multi-part file's overall “file handle.” Additionally, it is the catalog inode that is referenced by directory entries. The catalog may be the canonical repository for some metadata about the file, such as its ownership information, its ACL (if any), its Unix permissions, its authoritative qtree assignment, and the like, which are all stored authoritatively by the catalog inode. Most importantly, the catalog inode holds a small database that lists all the other inodes used by this multi-part file. In various embodiments, these other inodes are called the “child parts,” and they are the inodes that hold the actual payload that the client reads and writes.

Despite having these many different inodes involved, each multi-part file is expected to act—from the client's perspective—like any other regular file. Clients might not know how the file system has decided to arrange the use of storage and processing capacity for a file. Rather, the client wants to interact with their file through a regular network attached storage (NAS) protocol (e.g., NFS, SMB, multiprotocol support) and expects the file system to support full Portable Operating System Interface for Unix (POSIX) semantics in response. The file system might intentionally hide the topology of the multi-part file—or the fact that it is multi-part at all—ensuring that the internal storage topology not only helps the file system support the client's intention to just use this file as a file, but also allows the file system to rearrange the storage topology as needed later without interrupting client traffic.

One of the benefits realized using such techniques with multi-part files is that, because the file uses many inodes stored on many volumes and served by many controllers (e.g., data elements (data-blades or D-blades) thereof), the file system can serve traffic to that file in parallel without any one node, volume, or inode becoming a bottleneck. To achieve as much efficiency as possible with such parallelism, the data elements associated with respective child parts and are configured to perform input/output (I/O) (e.g., read operation, write operation) without frequently talking with each other. That is, the data elements operate independently relative to one another to avoid bottlenecks and latency. Likewise, the data elements performing the I/O might also operate mostly independently relative to the data element associated with the catalog inode. Problematically, however, achieving such parallelism during I/O comes into contention with accurate reporting of the file's collective properties, because write operations advance the file's attributes (e.g., file length, timestamps (access time (atime), modification time (mtime), and change time (ctime) (e.g., the times of most-recent access, data-modify, and/or metadata-modify).

Consider, for example, that a multi-part file has a current modification time including an indication that the file was last modified at time T; yet every write that affects this multi-part file, regardless of which data element owns the child parts involved in that write, needs to be able to advance that collective modification time. To efficiently perform those writes in parallel, the file system might not expect each write call to stall while it coordinates its write with the catalog: “I'm writing to part B of the file, so please advance the mtime to T+1”; “I'm writing to part D of the file, so please advance the mtime to T+2.” This sort of protocol might allow a multi-part file to reflect accurate metadata. At any time a user could ask the controller associated with the catalog inode “what are the current timestamps and length on this file?”, and the controller would already know because every controller performing I/O that could have changed those properties would have communicated with the controller to do so. But the cost of such a solution would be that every I/O would be forced to interact with the catalog for each operation, which would negatively impact performance of the file system.

The catalog inode typically does not include the current timestamps and length for the file, or at least, not at all times. Instead, each controller associated with a child part of the multi-part file may advance the timestamps and length on their own without talking with each other or with the catalog at all—and it's only when a client asks, that the controller associated with the catalog inode investigates the current file state. Following the above example of a three-part multi-part file with a catalog inode and child parts A, B, and C, part A in this example may be 10 GB in size (it's responsible for holding the client data starting at offset 0), part B may be 5 GB in size (it's responsible for holding the client data starting at offset 10 GB), and part C may be 8 GB in size (it's responsible for holding the client data starting at offset 15 GB), and all three parts show the current mtime as value T. If a client requests attributes of the file, the file system may return that the collective file currently has a length of 23 GB (because part C is the last part, and it holds data covering offsets 15 GB to 23 GB because of its current length) and that it has an mtime of T (because that is what all parts agree). Now, the file system identifies that writes can and should advance the mtime on a file, and that writes which span the end of the file can increase its length. Consider that at time T+1 part B receives a write that overwrites 1 GB of data. Part B accepts that overwrite, changes the data at that offset, and advances its own view of the mtime to be T+1. Then at T+2, part C receives a write request to grow the file by 1 GB. Part C accepts that request, writes the data to disk and grows its length accordingly from 8 GB to 9 GB while marking its own mtime as T+2. At time T+3, part A receives a write request to overwrite 1 GB of data, so part A accepts that write, overwrites the requested data, and advances its view of the mtime from T to T+3.

In the example above, the three writes were serviced by three controllers without any need to serialize: they did not talk with each other, and did not coordinate with the catalog. Instead, each was allowed to service its write on its own recognizance. This provides the highest I/O performance, because there is little additional work involved; however, this also comes with a cost. If any client then asks the file system, “how big is the file, and what is its mtime, at the moment?,” the file system might not have the information without further analysis. The file system accomplishes the investigation by querying each child part (for example, in parallel) (e.g., by using the RAL Bulkattr process). In response to this query part A will respond, “I think the file is at least 10 GB in size (because I hold data over the range 0 . . . 10 GB) and has mtime T+3,” while part B will respond, “I think the file is at least 15 GB in size (because I hold data over the range 10 GB . . . 15 GB) and has mtime T+1,” and part C will respond, “I think the file is at least 24 GB in size (because I hold data over the range 15 GB . . . 24 GB) and has mtime T+2.” The file system (or the catalog thereof) tallies these answers, such as by taking the greatest value from each response (since I/Os can only advance the timestamps and length, not reduce them). This allows the catalog to calculate that the correct collective client-visible length is 24 GB and its mtime is T+3.

This sort of attribute-tallying is expensive as it takes time to interrogate all these child parts, and the files system does that work while the client is waiting for an answer, which means the client experiences higher latency. To reduce that latency, in various embodiments of the present technology, the file system is able to persistently cache the properties that each child part reports. If the catalog happens to have a cache of these properties recorded for every child part, then when a client comes asking for the collective properties again it's now much faster for the catalog to respond, it can tally across those cached properties and report the answer, rather than checking with each child part again. Thus, when a subsequent get attribute (GetAttr) request is received by the file system, the file system may be able to read that cached tally to determine the correct length and timestamps to report to the client.

But caching in this way presents another problem: if there are cached child parts'properties saved in the catalog inode, such that the controller associated with the catalog inode is going to trust those cached properties and treat them as authoritative and correct values in this way, then those child parts are no longer free to change their own perception of the file without first invalidating those caches. That is, if a controller associated with child part B wants to service another write and/or read and advance its view of the mtime to T+4, that controller may first need to ensure that the catalog will no longer simply assume that child part B's prior report of “length 15 GB, mtime T+1” is still accurate. So as part of its preparation for serving an I/O, this controller may check whether its own record in the catalog reflects a promised-accurate cache of its properties. If there is a conflict, child part B may pause while it negotiates with the catalog: it expresses, “I want to make changes to child part B, so you to mark your cached attributes for that part stale.” Having cached properties for a part that are marked stale is a warning to the controller associated with the catalog inode that the child part might have previously reported these values but that the current values might have higher timestamps and greater length. Marking a child part's cached properties stale, therefore acts as a sign to the child part that it is free to service I/O that might change the file's timestamps and length-because the catalog has promised not to trust that the cached properties are accurate.

This introduces a basic bi-modality: the file system might be in such a state as to be ready to answer GetAttr queries quickly (because all child parts' properties are cached at the catalog), or it might be in such a state as to be ready to service I/O without any delays (because any cached child-part attributes that are saved in the catalog are also marked stale, indicating that the cache might now might be wrong). In various embodiments, the file system manages in which mode to operate based on heuristics. For example, the file system may recognize historical client traffic that includes a pattern of requests, such as: Write, Getattr, Write, Getattr, Write, Getattr, such that the file system might perform each write call quickly while also doing a lot of in-core tallies in between each otherwise-fast I/O. Similarly, the file system may recognize a pattern of requests including a combination of reads and Getattr requests, among other combinations of requests. Upon identifying request activity that might trigger the file system to determine current attributes for a file multiple times over a duration, the file system (i.e., a controller thereof) can delegate attribute authority to a particular controller, such that a network element (e.g., a protocol interface layer between a client and the file system) is granted exclusive authority to edit attributes of the file for a given time. When delegated this attribute authority, the network element of a controller has exclusive permissions to change the attributes of the multi-part file, such that attributes edited by the authoritative network element can be trusted by the other controllers as none of the other controllers can edit the attributes during the duration the network element has attribute authority. For example, the authoritative network element may be sufficiently accurate to conform to POSIX semantics. Thus, when the network element receives a write request or a read request, the network element can utilize a cache with which to track the latest attributes without the need for other controllers to determine attributes for the file by querying other caches and tallying results, potentially bottlenecking the I/O process.

Various embodiments of the present technology provide for a wide range of technical effects, advantages, and/or improvements to computing systems and components. For example, various embodiments may include one or more of the following technical effects, advantages, and/or improvements: 1) non-routine and unconventional operations and algorithms for large-scale storage architectures that store files in multiple parts across storage devices (e.g., drives) that are managed by multiple controllers or nodes; 2) non-routine and unconventional operations and components that create an exclusive authority over editing attributes of a multi-part file stored and managed by multiple controllers or nodes; 3) non-routine and unconventional operations for obtaining and consolidating attributes for a multi-part file, stored and managed by multiple controllers or nodes, across the multiple controllers and caching accurate and up-to-date attributes; 4) non-routine and unconventional operations for requesting to delegate attribute authority to one of the multiple controllers for exclusive permissions to edit attributes for a multi-part file to allow the delegated authority to act as a proxy for a client with respect to an authority over the management of the attributes; 5) non-routine and unconventional operations for determining when to request to delegate attribute authority to one of the multiple controllers based on heuristic analysis of I/O activity between the one controller and a client; 6) non-routine and unconventional operations for removing exclusive authority over attributes from a controller; 7) non-routine and unconventional operations to track states of parallel write operations and resulting attributes from each write operation while attribute authority is delegated to a controller performing the parallel write operations; 8) non-routine and unconventional operations to track states of parallel read operations and resulting attributes from each read operation while attribute authority is delegated to a controller performing the parallel read operations, among other benefits.

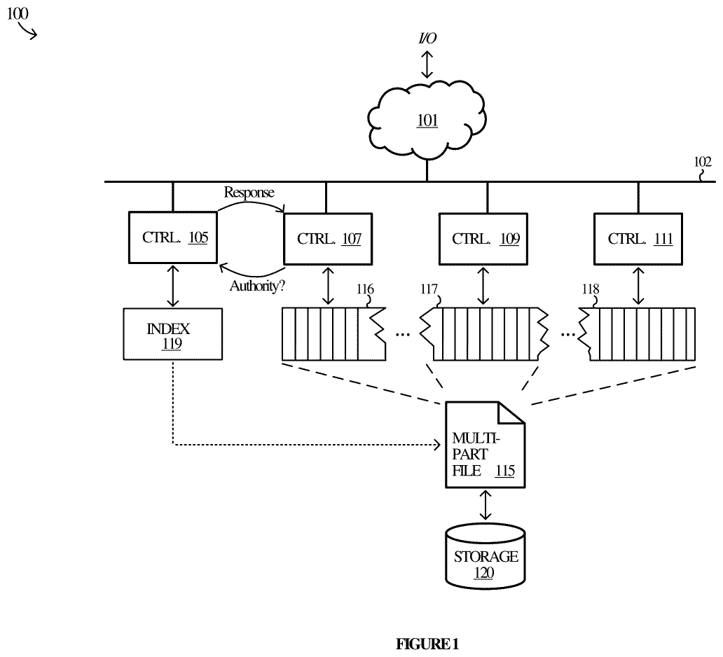

FIGS. 1, 2, 3, 4, 5A, 5B, 5C, and 6 below illustrate and describe additional details of such systems, devices, and methods.

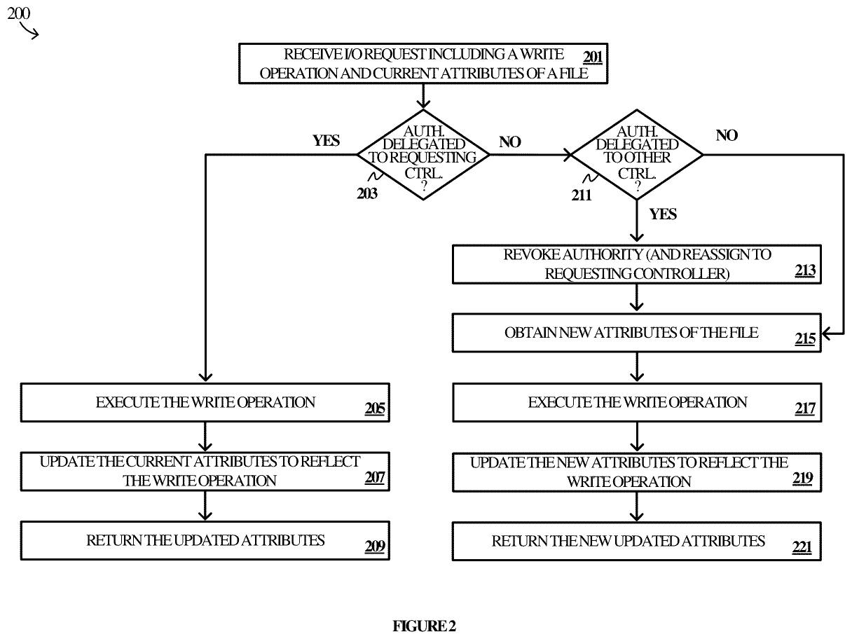

Referring now to the Figures, FIG. 1 illustrates an example data storage system in an implementation. FIG. 1 shows data storage system 100, which includes network 101, network 102, controllers 105, 107, 109, and 111, and storage 120. Controllers 105, 107, 109, and 111 may be configured to create multi-part file 115 for storage on storage 120, as well as manage attributes of multi-part file 115. For example, controllers 105, 107, 109, and 111 may perform attribute management processes, such as method 200 of FIG. 2 below, and may implement hardware, software, and/or firmware, as well as combinations and variations thereof.

In various embodiments, operating environment 100 is representative of a data storage environment that includes hardware, software, and firmware components capable of providing file system services, such as file storage and management, among other functionality. In some embodiments, operating environment 100 includes multiple controllers and multiple storage devices arranged in a disaggregated, shared architecture where each of the controllers is capable of accessing any of the storage devices. In particular, controllers 105, 107, and 109 can receive requests to perform input/output (I/O) operations (e.g., read operations, write operations) via network 101 and perform the I/O operations with all of the storage devices of storage 120. In some embodiments, the controllers and storage devices of operating environment 100 are arranged in a one-to-one architecture where each of the controllers is capable of exclusively accessing one or more of the storage devices.

Network 101 is representative of a communication network through which enterprise clients, servers, and devices provide read requests and write requests (i.e., I/O) to a data storage system, such as a system including controllers 105, 107, and 109, and storage 120. Communication between the enterprise clients and controllers 105, 107, and 109 may occur over network 101 and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

Controllers 105, 107, and 109 are representative of devices, systems, servers, or services capable of accessing and managing storage for enterprises and users in communication with controllers 105, 107, and 109 via network 101. Controllers 105, 107, and 109 also interface with each other and with storage 120 in accordance with one or more storage network and access protocols, such as Non-Volatile Memory Express (NVMe), via network 102. Other protocols such as Network File System (NFS), Server Message Block protocol (SMB), Internet Small Computer System Interface (iSCSI), Fiber Channel (FC), Fiber Channel over Ethernet (FCoE), and the like may be contemplated. By way of example, each of controllers 105, 107, and 109 may be a server configured to run an instance of a storage operating system (e.g., NetApp ONTAP® (without derogation of trademark rights of NetApp Inc., the assignee of this application)) to perform I/O operations based on I/O requests received through network 101, among other functions.

Storage 120 is representative of a cluster of storage devices that provide storage in operating environment 100. Examples of the storage devices include flash disks and/or capacity drives, such as hard-disk drives (HDDs) and solid state drives (SSDs), as well as combinations and variations thereof. In various embodiments, storage 120 includes groups of the storage devices, which may provide redundancy relative to one another. In a shared architecture, controllers 105, 107, and 109 may access each storage device of storage 120. More particularly, controllers 105, 107, and 109 may access each storage device of storage 120 at different locations (e.g., ranges of addresses) thereof based on metadata associated with the system.

In various embodiments, controllers 105, 107, 109, and 111 are configured to store and manage files at storage 120, such as multi-part file 115. Multi-part file 115 may be representative of a large file, e.g., in the terabyte range, that the controllers determine to distribute (e.g., via a granular data distribution (GDD) technique) across multiple storage devices of storage 120 by multiple of the controllers. As shown in operating environment 100, multi-part file 115 includes three-parts, each of which may be owned by a different one of the controllers of operating environment 100. In particular, part 116 is associated with controller 107 and corresponds to a beginning part of multi-part file 115, part 117 is associated with controller 109 and corresponds to a middle part of multi-part file 115, and part 118 is associated with controller 111 and corresponds to an end part of multi-part file 115.

More specifically, each controller may be assigned a set of locations at which the controllers can write to storage 120 and read from storage 120. The set of locations may be referred to as an allocation area. The allocation areas may span multiple storage devices of storage 120, or they may be limited to a single storage device of storage 120. Each file stored at storage 120 may be stored at locations indicated in an index node, or inode, corresponding to one or more allocation areas. Accordingly, each controller may “own” a part of multi-part file 115 as part of the controller's access permissions with respect to storage 120.

In various embodiments, controller 105 might not own a part of multi-part file 115 relative to writing and reading data based on input/output (I/O) requests. Instead, controller 105 is associated with index 119, which represents a catalog index of multi-part file 115. Index 119 includes indications of ownership of each part of multi-part file 115, as well as metadata associated with multi-part file 115. For example, index 119 may indicate that part 116 is associated with controller 107, part 117 is associated with controller 109, and part 118 is associated with controller 111. Index 119 may also indicate sizes (e.g., length) of each part, offsets (e.g., beginning locations/addresses and end locations/addresses) of each part, timestamps related to modification times of the parts, access times of the parts, and the like. This information may be referred to as file attributes.

In various embodiments, controllers 107, 109, and 111 store attributes of respective parts of multi-part file 115 in respective caches. For example, upon performing a write request or a read request corresponding to part 116, controller 107 stores attributes that reflect a respective operation performed on part 116. However, controllers 107, 109, and 111 may track attributes irrespective of another as the controllers might only track attributes of respective parts. And controller 105 might not track the overall attributes for multi-part file 115, at least not at all times. To track the overall attributes for multi-part file 115, controller 105 can query each cache of controller 107, 109, and 111 and determine the overall attributes based on a combination of the attributes from the caches. However, this may require significant processing capacity and time, reducing efficiency of the performance of the controllers. Therefore, the controllers implement a process disclosed herein for delegating authority to one of the controllers to maintain a ground truth set of attributes for a duration when I/O traffic is heavy with respect to writes to multi-part file 115.

Delegating authority over attributes of multi-part file 115 may entail locking permissions to change the attributes to one of the controllers for a duration. During this time, attributes determined and/or cached by non-authoritative controllers may be indicated as stale or inaccurate. Contrarily, the attributes determined and/or cached by an authoritative controller are indicated as accurate and are used by one of the controllers to return post-operation attributes to a client via network 101. In various embodiments, an indication of which, if any, controller has authority over the attributes (also referred to as attribute authority) may be stored in index 119.

In various embodiments, a controller may determine to delegate attribute authority to itself or to another controller based on heuristics related to the I/O traffic to a controller from a client via network 101. For example, one of the controllers may delegate attribute authority upon identifying a number of I/O requests to a controller exceeds a threshold number of I/O requests within a threshold duration of time. The controller that provides attribute authority may also be the same controller that removes attribute authority after a duration or after a shift in a pattern of I/O traffic. As such, removal of attribute authority may also be based on heuristics.

By way of an example, in operation, controller 107 receives an I/O request from a client via network 101. The I/O request may include a write operation and a get attribute operation. The write operation includes data to be written to part 116, and the get attribute operation includes a request to return attributes, such as file length, to the client after controller 107 executes the write operation. Controller 107 performs the write operation at part 116. Controller 107 checks whether it has attribute authority by querying index 119 via controller 105. Controller 105 returns a response to the query including an indication of attribute authority. If controller 107 does not have attribute authority, controller 107, or another controller, may query each other controller for current attributes, then determine the overall attributes based on the returned attributes. If controller 107 does have attribute authority, controller 107 identifies current attributes stored in its cache and updates the current attributes to reflect the write operation performed on part 116. Then, controller 107 stores the updated attributes in the cache and returns the updated attributes to the client via network 101 in response to the get attribute request.

While only a single multi-part file and set of controllers are shown in operating environment 100, operating environment 100 may include fewer or additional elements, such as additional or fewer controllers, storage devices, networks, indices, and the like. Additionally, while the above example refers to a combination of a write operation and a get attribute operation, it may be appreciated that similar operations may be performed for other variations and combinations of operations, including read operations which may also alter the attributes of multi-part file 115.

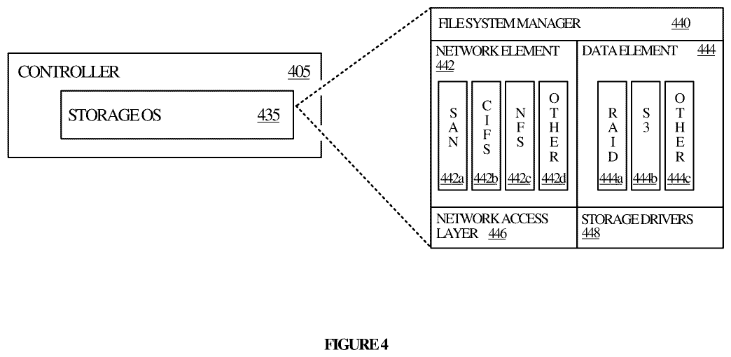

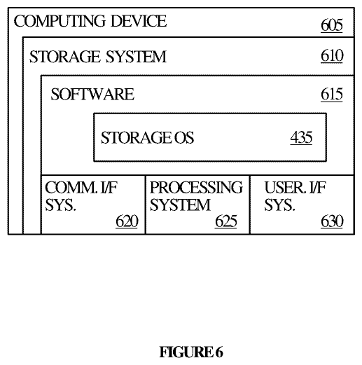

FIG. 2 illustrates a method for managing storage controllers in a data storage environment in an implementation. Method 200 may be employed by a computing device, such as a controller of operating environment 100 (e.g., one of controllers 105, 107, and 109), examples of which are provided by controller 410 of FIG. 4 and computing system 605 of FIG. 6. Accordingly, method 200 may be implemented in hardware, software, and/or firmware, and may be implemented in program instructions executable by one or more processors of the computing device. The program instructions direct the computing device to operate in accordance with the steps of method 200, which reference elements of FIG. 1. For the sake of simplicity, the following steps of method 200 are described as being performed by controller 107, however, other controllers may additionally, or instead, perform the steps. In some embodiments, different elements of controller 107, such as a network element (e.g., a network interface element, e.g., network element 442) and a data element (e.g., a storage interface element, e.g., network element 444), may be responsible for performing certain steps of method 200, which are noted parenthetically in the discussion below.

To begin, in operation 201, controller 107 (e.g., a network element of controller 107) receives an I/O request from a client via network 101. In various embodiments, the I/O request includes a write operation and a get attribute operation. The write operation includes data to be written to part 116 of multi-part file 115, and the get attribute operation includes a request to return attributes, such as file length, to the client after controller 107 executes the write operation. In some such embodiments, controller 107 receives the write operation from the client, then receives the get attribute operation after the write operation in a sequential order. The I/O request may be the first such I/O request over a duration, or it may be the nth I/O request over a duration. In some embodiments, the I/O request may additionally or alternatively include a read operation that identifies a location of storage 120 at which to read data.

In operation 203, controller 107 (e.g., a data element of controller 107) checks whether it has attribute authority by querying index 119 via controller 105. Attribute authority may refer to permissions to edit attributes for multi-part file 115, such as advancing timestamps and expanding the file length, among other properties, and permissions to cache the attributes as up-to-date indications that other controllers can reference as truthful and accurate attributes. Controller 105 returns a response to the query from controller 107 including an indication of attribute authority.

If controller 107 does have attribute authority, in operation 205, controller 107 identifies current attributes stored in its cache (e.g., by the network element of controller 107), executes the write operation (e.g., by the data element of controller 107), and updates the current attributes (e.g., by the data element of controller 107) to reflect the write operation performed on part 116. Executing the write operation may entail identifying one or more locations among storage 120 at which to write the data specified in the I/O request and writing the data at the one or more identified locations. Controller 107 may identify the locations based on metadata stored in-memory of controller 107 and/or in storage 120. Updating the current attributes may entail advancing a timestamp of multi-part file 115 and/or editing a file length attribute, based on the write operation, of currently cached attributes obtained by controller 107 by querying its attribute cache. Then, controller 107 stores the updated attributes in the cache.

In operation 209, controller 107 returns the updated attributes to the client via network 101 in response to the get attribute request (e.g., by the network element of controller 107).

If controller 107 does not have attribute authority, controller 107 next determines whether another controller has been delegated attribute authority in operation 211 (e.g., by the network element of controller 107). Controller 107 may identify such a delegation to a different controller based on the indication of attribute authority. If another controller currently holds attribute authority, controller 107 (e.g., by the data element of controller 107), in operation 213 revokes authority and reassigns attribute authority to itself (i.e., to the network element of controller 107).

Next, after reassignment of attribute authority to controller 107, or if neither controller 107 nor another controller have attribute authority, in operation 215, controller 107 obtains new attributes of multi-part file 115 (e.g., by the data element of controller 107). This may entail controller 107 querying each other controller for current attributes stored in respective caches, then determining the overall attributes based on the returned attributes. In operation 219, controller 107 updates the overall attributes of multi-part file 115 to reflect the write operation performed in operation 203, resulting in new overall attributes. Controller 107 may additionally store the updated attributes in a cache. Next, in operation 221, controller 107 returns the new overall attributes to the client via network 101 as a response to the get attribute request.

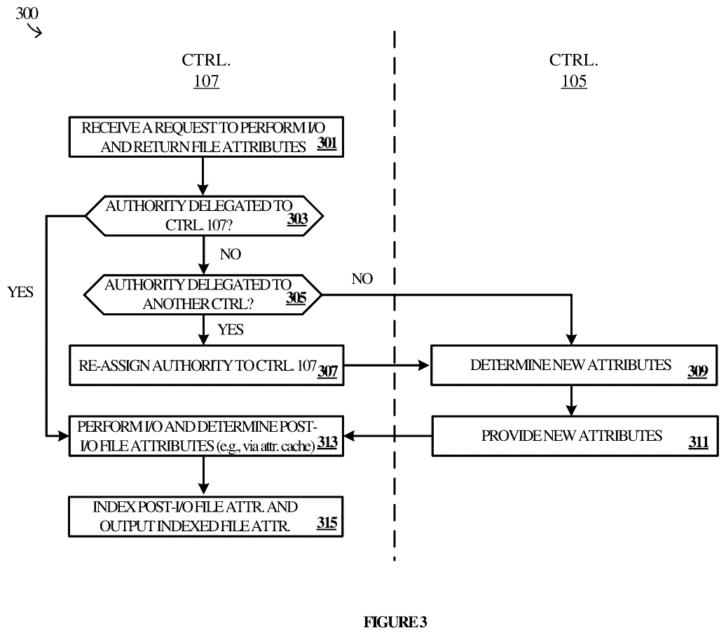

FIG. 3 illustrates an example operational sequence performed by storage controllers of a data storage system in an implementation. FIG. 3 shows sequence 300, which includes and references elements of data storage system 100 of FIG. 1, such as controllers 105 and 107, multi-part file 115, and storage 120.

To begin, in operation 301, controller 107 receives an I/O request from a client via network 101. In various embodiments, the I/O request includes a write operation and a get attribute operation. The write operation includes data to be written to part 116 of multi-part file 115, and the get attribute operation includes a request to return attributes, such as file length, to the client after controller 107 executes the write operation. In some such embodiments, controller 107 receives the write operation from the client, then receives the get attribute operation after the write operation in a sequential order. The I/O request may be the first such I/O request over a duration, or it may be the nth I/O request over a duration. In some embodiments, the I/O request may additionally or alternatively include a read operation, as well as a combination or variation of read, write, and get attribute operations.

In operation 303, controller 107 checks whether it has attribute authority by querying index 119 via controller 105. Attribute authority may refer to permissions to edit attributes for multi-part file 115, such as advancing timestamps and expanding the file length, among other properties, and permissions to cache the attributes as up-to-date indications that other controllers can reference as truthful and accurate attributes.

If controller 107 does not have attribute authority, controller 107 next determines whether another controller has been delegated attribute authority. Controller 107 may identify such a delegation to a different controller based on the indication of attribute authority. If another controller currently holds attribute authority, controller 107 (e.g., by the data element of controller 107), in operation 307, revokes authority and reassigns attribute authority to itself (i.e., to the network element of controller 107).

Next, after reassignment of attribute authority to controller 107, or if neither controller 107 nor another controller have attribute authority, in operation 309, controller 105 (e.g., via a data element of controller 105) obtains new attributes of multi-part file 115. This may entail controller 105 querying each other controller for current attributes stored in respective caches, then determining the overall attributes based on the returned attributes. Next, in operation 311, controller 107 returns the newly determined attributes to controller 107.

If controller 107 does have attribute authority, controller 107 bypasses controller 105 determining new attributes, which improves efficiency and reduces time and processing capacity as the attributes previously cached by controller 107 are up-to-date. As a result, controller 107 proceeds to operation 313. However, if controller 107 does not have attribute authority, controller 107 receives new attributes from controller 105 as described above, then proceeds to operation 313. In operation 313, controller 107 executes the write operation at part 116. This may entail identifying one or more locations among storage 120 at which to write the data specified in the I/O request. Controller 107 may identify the locations based on metadata stored in-memory of controller 107 and/or in storage 120.

In operation 315, controller 107 updates the attributes to reflect the write operation performed in operation 305, resulting in new overall attributes. Controller 107 may additionally store the updated attributes in a cache and return the new overall attributes to the client via network 101 as a response to the get attribute request.

FIG. 4 illustrates an example controller suitable for implementing the various systems, operational environments, architectures, environments, methods, processes, scenarios, sequences, and frameworks discussed below with respect to the other Figures. FIG. 4 shows controller 405, which is representative of any system or collection of systems in which the various applications, processes, services, and scenarios disclosed herein may be implemented. Examples of the computing apparatus illustrated by controller 405 include, but are not limited to server computers, web servers, cloud computing platforms, and data center equipment, as well as any other type of physical or virtual server machine, container, and any variation or combination thereof. In some examples, computing device 405 may also be representative of desktop and laptop computers, tablet computers, and the like.

In some cases, controller 405 is representative of a storage controller in a data storage system. In such cases, storage operating system 435 is representative of a generic example of an operating system of a storage controller. In one example, storage operating system 435 may include several modules, or “layers” executed by one or both of a network module (e.g., a network element or network blade (N-blade)) and a storage module (e.g., a data element or data blade (D-blade)). These layers include a file system manager 440 that keeps track of a hierarchical structure of the stored data and manages read/write operation, i.e., executes read/write operation on storage in response to I/O requests, as described above in detail. In some cases, file system manager 440 interfaces with a failover module during a failover operation to enable access to storage managed by a failed storage system node via a partner storage system node.

In particular, storage operating system 435 may includes a network element 442 (e.g., a protocol layer) and an associated network access layer 446, to allow storage nodes to communicate over a network with other systems, such as network 101 and network 102 of FIG. 1. Network element 442 may implement one or more of various higher-level network protocols, such as SAN (e.g., iSCSI) (442a), CIFS (442b), NFS (442c), Hypertext Transfer Protocol (HTTP) (not shown), TCP/IP (not shown) and others (442d).

Network access layer 446 may include one or more drivers, which implement one or more lower-level protocols to communicate over the network, such as Ethernet. Interactions between host systems and mass storage devices are illustrated schematically as a path, which illustrates the flow of data through storage operating system 435.

The storage operating system 435 may also include a data element 444 (e.g., a storage access layer) and an associated storage driver layer 448 to allow a storage controller to communicate with a storage device. The data element 444 may implement a higher-level storage protocol, such as RAID (444a), a S3 layer 444b to access a capacity tier for object-based storage (not shown), and other layers 444c. In particular, method 200 is representative of at least a portion of an authority delegation and attribute management process performable by controller 405. The storage driver layer 448 may implement a lower-level storage device access protocol, such as Fiber Channel or SCSI. The storage driver layer 448 may maintain various data structures (not shown) for storing information regarding storage volume, aggregate and various storage devices.

As used herein, the term “storage operating system” generally refers to the computer-executable code operable on a computer to perform a storage function that manages data access and may, in the case of a storage system node, implement data access semantics of a general-purpose operating system. The storage operating system can also be implemented as a microkernel, an application program operating over a general-purpose operating system, or as a general-purpose operating system with configurable functionality, which is configured for storage applications as described herein.

In addition, it will be understood to those skilled in the art that the disclosure described herein may apply to any type of special-purpose (e.g., file server, filer or storage serving appliance) or general-purpose computer, including a standalone computer or portion thereof, embodied as or including a storage system. Moreover, the teachings of this disclosure can be adapted to a variety of storage system architectures including, but not limited to, a network-attached storage environment, a storage area network and a storage device directly attached to a client or host computer. The term “storage system” should therefore be taken broadly to include such arrangements in addition to any subsystems configured to perform a storage function and associated with other equipment or systems. It should be noted that while this description is written in terms of a write any-where file system, the teachings of the present disclosure may be utilized with any suitable file system, including a write in place file system.

The following Figures show exemplary processes performed by a protocol layer and a storage access layer of a controller, such as network element 442 and data element 444, respectively, of controller 405.

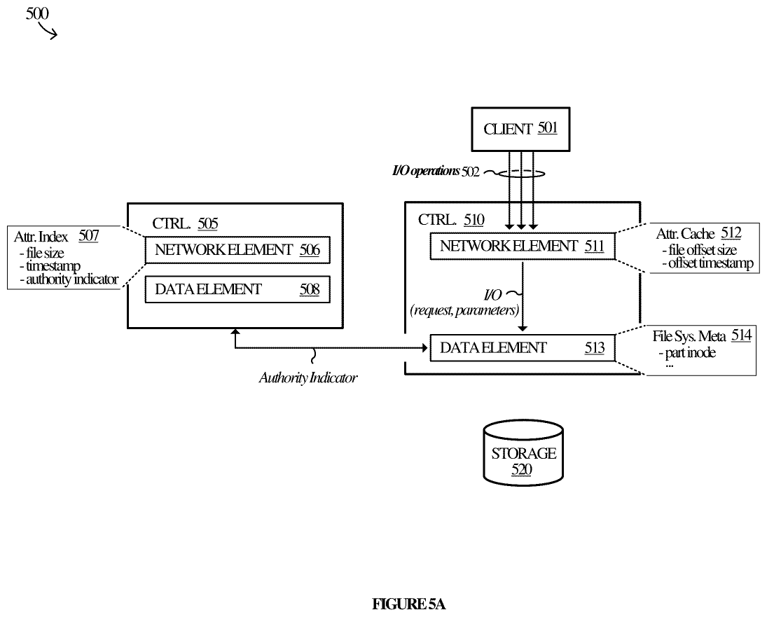

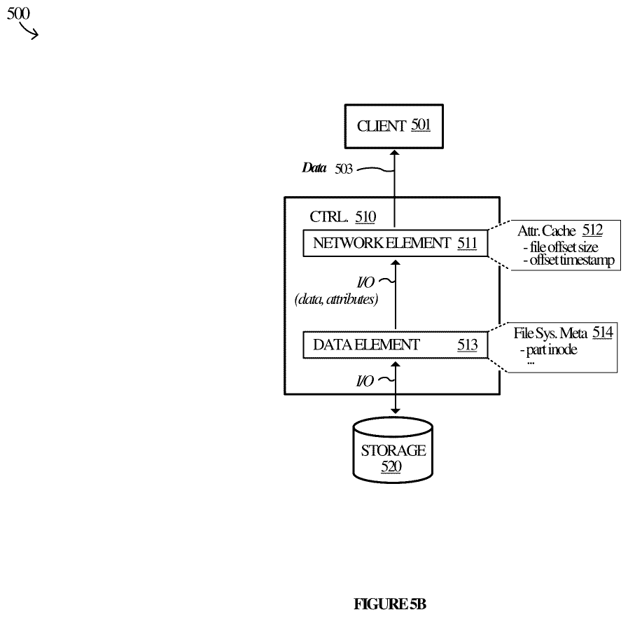

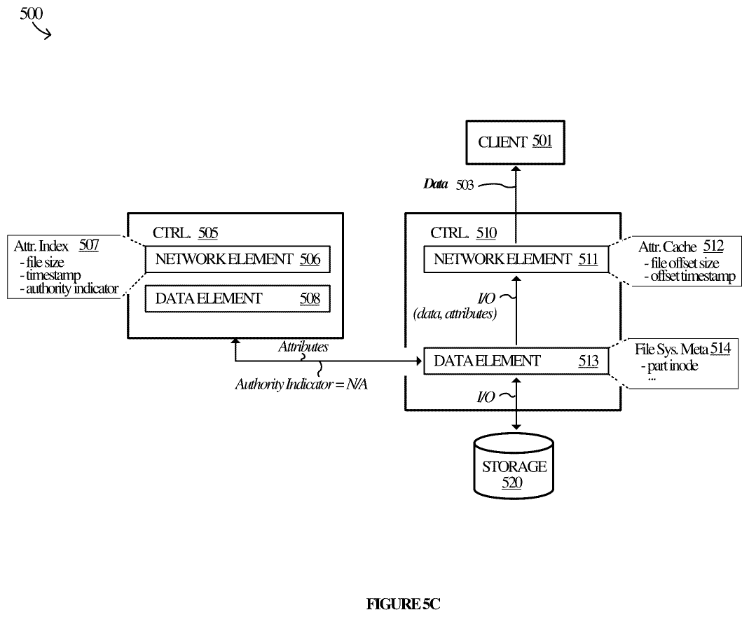

FIGS. 5A, 5B, and 5C illustrate example operating environments in which multi-part file and attribute management operations may be performed in an implementation. FIGS. 5A, 5B, and 5C show operating environment 500, which may be representative of a data storage environment in which a data storage system provides file storage, file management, and file attribute management for clients, such as by performing method 200 of FIG. 2. Operating environment 500 includes controller 510 and storage 520, which form at least part of the data storage system, and also includes client 501.

Referring first to FIG. 5A, FIG. 5A shows operating environment 500 at a first time during which client 501 provides I/O operations 502 to controller 510 via a communication network (e.g., via network 101 of FIG. 1). I/O operations 502 may include one or more write requests, read requests, and attribute requests (e.g., a get attribute request) corresponding to a file stored at storage 520 (e.g., an aggregate of storage devices, e.g., storage 120) by controller 510 or another controller. In various embodiments, the write requests, read requests, and attribute requests are provided to controller 510 by client 501 in a sequential order. For example, for I/O operations 502 including a write request and an attribute request, client 501 first provides a write request followed by an attribute request, then provides another write request followed by another attribute request, and so on.

To process I/O operations 502, controller 510 includes network element 511 and data element 513. Network element 511 is representative of a protocol layer (e.g., network element 442) capable of interfacing with client 501 to receive I/O operations 502 and return data to client 501 over a communication network. Data element 513 is representative of a storage access layer (e.g., data element 444) capable of interfacing with network element 511 to receive I/O operations 502, interfacing with storage 520 to perform I/O operations 502, and interfacing with network element 511 to return information to network element 511 in response to completing I/O operations 502.

Network element 511 communicates with attribute cache 512, representative of a cache that stores information about a file (e.g., multi-part file 115) owned by controller 510 and stored in storage 520. For example, attribute cache 512 may store attributes associated with the file, such as a file offset size, offset timestamps, and the like, where the offset corresponds to a part of the file owned by controller 510 (e.g., part 116 of multi-part file 115). In some embodiments, attribute cache 512 stores attributes for a part of a multi-part file owned by controller 510 as opposed to attributes for the whole multi-part file. In some such embodiments, a different controller communicates with a cache index that stores attributes for the whole multi-part file. In some embodiments, however, attribute cache 512 stores attributes for the whole multi-part file in scenarios, such as when network element 511 has been delegated authority over the attributes for the multi-part file.

Data element 513 communicates with file system metadata 514, representative of information about storage 520, controller 510, other controllers in a data storage system, and the like. For example, file system metadata 514 may include indications about files owned by controller 510, locations at which the files are stored within storage 520, access permissions with respect to the locations within storage 520, and the like. In particular, file system metadata 514 may indicate to which index nodes, or inodes, data element 513 can write, and which files, or parts thereof, are associated with the inodes.

In operation, upon receiving I/O operations 502, network element 511 identifies a data element associated with the part of the multi-part file specified in I/O operations 502. In the example illustrated in FIG. 5A, network element 511 determines that data element 513 is associated with the part. In some embodiments, however, network element 511 may route I/O operations 502 to a data element of a different controller. Network element 511 also queries attribute cache 512 to identify whether attribute cache 512 holds any attributes for the part of the multi-part file. If so, network element 511 attaches the current attributes from attribute cache 512 to I/O operations 502 and provides I/O operations 502 to data element 513. Collectively, I/O operations 502 may also be referred to simply as a write operation or a read operation, however, I/O operations 502 may include a combination of both the write operation, or read operation, and the current attributes queried from attribute cache 512.

In various embodiments, prior to performing I/O operations 502, data element 513 determines whether network element 511 has been delegated authority over the attributes of the multi-part file. In other words, data element 513 determines whether the attributes that network element 511 provided to data element 513 along with I/O operations 502 are trustworthy and accurate. To determine whether network element 511 has been delegated attribute authority, data element 513 communicates with controller 505, representative of another controller in the data storage system that is associated with a catalog index holding information about the whole multi-part file and each controller involved with the multi-part file.

Controller 505 includes network element 506 and data element 508, which are representative of protocol and storage access layers, respectively, of controller 505. Network element 506 of controller 505 communicates with attribute index 507, which is representative of storage that holds information about the multi-part file stored in storage 520 (e.g., index 119 of FIG. 1). For example, attribute index 507 includes file attributes, like file size and file timestamps, for the whole multi-part file. The indications in attribute index 507 might not always be up-to-date, however, as many different controllers may be performing I/O operations at any given time. An example of controller 505 updating the attributes in attribute index 507 is described below with respect to FIG. 5C.

Attribute index 507 also includes an authority indicator. The authority indicator may include a value (e.g., 0, 1) indicative of whether a controller in the data storage system has been delegated attribute authority, as well as a value indicative of the controller's identity.

In the example shown in FIG. 5A, data element 513 determines that network element 511 has been delegated attribute authority based on the authority indicator in attribute index 507. As a result, data element 513 determines that the attributes provided by network element 511 are accurate, up-to-date attributes for the multi-part file because the attribute authority indicates that the attributes are locked for editing by network element 511 and are unavailable for editing by other controllers, including controller 505, during the duration that network element 511 has attribute authority.

In various embodiments, network element 511 may be granted attribute authority some time before receiving I/O operations 502 from client 501, or at some time after receiving I/O operations 502 and before data element 513 returns attributes to network element 511. By way of example, upon receiving a set of I/O operations from network element 511 prior to receiving I/O operations 502, data element 513 heuristically determines that the set of I/O operations results in heavy I/O traffic between client 501 and controller 510. In some embodiments, this may entail data element 513 determining that the number I/O operations received by network element 511 exceeds a threshold number of I/O operations over a threshold duration. Accordingly, data element 513 can delegate attribute authority to network element 511 so that network element 511 has exclusive permissions to edit and cache the attributes in attribute cache 512 for a duration. By way of another example, upon receiving I/O operations 502, data element 513 heuristically determines that I/O operations 502 causes the traffic between client 501 and controller 510 to exceed a threshold activity level. Accordingly, data element 513 may grant attribute authority to network element 511 after network element 511 receives I/O operations 502.

Once data element 511 determines to delegate attribute authority to network element 511, data element 513 updates the authority indicator in attribute index 507. Data element 513 may also be configured to obtain up-to-date attributes for the whole multi-part file before attributes output by network element 511 can be deemed trustworthy and accurate. An example of obtaining new attributes with which to update attribute cache 512 is described below with respect to FIG. 5C.

After the identified pattern of I/O operations from client 501 to network element 511 stops or reduces below a threshold activity level, data element 513, or another data element, can remove attribute authority from network element 511 by updating the authority indicator in attribute index 507. An example in which network element 511 does not have attribute authority is shown and described in FIG. 5C.

Referring next to FIG. 5B, FIG. 5B shows operating environment 500 at a second time following the first scenario shown and described in FIG. 5A. Accordingly, the second time corresponds to a time after data element 513 determines that network element 511 has attribute authority.

Upon data element 513 receiving I/O operations 502 from network element 511, data element 513 determines to which locations within storage 520 to write the data in accordance with I/O operations 502 based on file system metadata 514. Next, data element 513 executes the write operation by writing the data to storage 520.

Upon completing performance of a write operation and/or read operation, data element 513 updates the attributes to reflect the performance of the write and/or read operation. In particular, this may entail advancing timestamps or file lengths based on the data written to storage 520 and the time at which data element 513 writes/reads the data to/from storage 520. This results in updated attributes. Data element 513 provides the updated attributes and an indication of completion of the write operation to network element 511.

Network element 511 receives the updated attributes and stores the updated attributes in attribute cache 512. Network element 511 returns data 503, including the updated attributes, to client 501 via the communication network.

Referring next to FIG. 5C, FIG. 5C shows operating environment 500 when network element 511 is not delegated attribute authority. This may correspond to a time before or after the times shown and described above with respect to FIGS. 5A and 5B.

In the example shown in FIG. 5C, data element 513 determines that network element 511 has not been delegated attribute authority based on the authority indicator in attribute index 507. Data element 513 may thus be configured to ignore the attributes provided by network element 511 and obtain new attributes for return to network element 511 to be cached and used for current and future I/O operations. In some embodiments, this may entail data element 513 querying attribute caches and/or attribute index 507 of the other controllers in the data storage system to receive respective attributes and determining new attributes based on a combination of each controller's cached attributes. This results in new attributes that can be stored in attribute cache 512 by network element 511. In some embodiments, data element 508 of controller 505 may instead obtain and generate the new attributes and store the new attributes in attribute index 507 for reading by data element 513.

After determining the new attributes, data element 513 executes the write and/or read operation of I/O operations 502 and updates the new attributes to reflect the write and/or read operation. This results in a new update attributes. Data element 513 returns the new updated attributes to network element 511. Network element 511 then provides the new updated attributes to client 501 via the communication network. Optionally, network element 511 caches the new updated attributes.

While the above scenarios describe implementations where a single controller processes I/O operations from a single client, it may be appreciated that the techniques described herein may be applied across multiple controllers and multiple I/O streams, which may provide various technical benefits, such as increased data storage and I/O efficiency resulting in reduced latency and bottlenecking when determining file attributes. Such processes lead to improved multi-part file management and multi-part file attribute management, especially under I/O activity patterns where clients continuously request for file attributes after each write request.

In various embodiments, when a network element (e.g., network element 511) has more than one request outstanding at one time, it may be appreciated that no NAS protocol provides guarantees to a client (e.g., client 501) about which requests are serviced first, and neither does the controller (e.g., controller 510) attempt to guarantee which responses are received by the client first (which might be a very different from the order in which the requests were received or processed by the controller). This is one of the reasons that the timestamps on a file are important for many NAS clients, so that these parallel operation responses can be received in any order and the client-side cache can be updated correctly to reflect “I did this write first, then I did this write” etc.

As an example, a network element might receive a first write request that wants to grow a file through a write at offset 24 GB (the current end of file (EOF)) for 1 MB. The network element sends that request to a data element (e.g., data element 513) for service. And while that work is still outstanding, the network blade might receives another request asking to write at the offset (24 GB+1 MB) for 1 MB. The network element sends that request to the data element (in this case, probably the same one) for service. Now, there is no guarantee about which of these requests will be handled first by the data element. It may be possible that the data element will start the first request, have to stall while an inode is loaded or memory is allocated, for example, and execute the second write before the first write now that its path has been prepared. For both of these requests, the network blade had sent attributes indicating that the file was 24 GB in size as part of its request because that's what was in the network element's attribute cache (e.g., attribute cache 512) at the time the messages passed through. When the data element executes the second write growing the file to a larger size (i.e., 24 GB+2 MB) and returns the new file size to the network blade, the data element may next have to execute the first write. However, the data element discovers that by performing the first write, it is just filling a hole over the range 24 GB to 24 GB+1 MB. Typically, it would better for the data element to execute the second write to incorporate the true (24 GB+2 MB) size into its response path, because it can, but because these messages are disjoint (e.g., they're working on non-overlapping regions of the file), it is not strictly necessary for the post-execution attributes from the second write to indicate the 24 GB+2 MB size. This may be because, from the client's point of view, there was no guarantee about service order-and since the writes did not overlap, the true order in which the messages were serviced does not matter.

If the client writes do overlap, then the order in which they were serviced is important to note. Thus, when a particular data element is involved, it can consult the properties of the child parts involved in its message and integrate that information into the responses that it returns.

In some embodiments, the controllers in a data storage environment may utilize a NFS4.2 protocol with pNFS. The pNFS protocol is unusual in the NAS world, in that it allows a client to ask the server to explain the topology for its storage, so that the client can direct its I/O calls to an optimal LIF based on the offset being read or written-and in this protocol, the topology can encompass any LIF in the cluster, not just in a single N-blade.

At first blush, this breaks the premise of attribute authority delegation because now a client process might send a write to one network element followed by a different write to another network blade. When multiple network elements are involved, this model might not allow either network element to act as a proxy for the client like in the above scenarios shown and described in FIGS. 5A, 5B, and 5C. However, the NFS4 protocol is different from NFS3 and CIFS in that it does not ask for (and does not accept) post-operation attributes to be returned a part of its I/O calls. NFS4 uses explicit client-to-server delegations to ensure client-side cache coherence, rather than relying on NFS3's weak cache consistency or close-to-open cache semantics. Therefore, a pNFS client that is performing lots of I/O calls to a multi-part file has actually already obtained a guarantee of exclusivity and does not need the data storage system to acknowledge or even attempt to explain which I/Os were serviced in what order or what the file properties are along the way. The primary thing the storage controller needs to be sure of is that when a client sends request to return file attributes, the storage controller should return accurate answers. And by disallowing use of delegated attribute authority for pNFS clients, the storage controller implicitly falls back on the safe process of performing an in-core tally to get accurate answers in this case.

FIG. 6 illustrates computing device 605, which is representative of any system or collection of systems in which the various applications, processes, services, and scenarios disclosed herein may be implemented. Examples of computing apparatus illustrated by controller 405 include, but are not limited to server computers, web servers, cloud computing platforms, and data center equipment, as well as any other type of physical or virtual server machine, container, and any variation or combination thereof. In some examples, computing device 605 may also be representative of desktop and laptop computers, tablet computers, and the like. For example, computing device 605 may be implemented as a controller in a data storage environment, an example of which is shown and described above as controller 405 of FIG. 4.

Computing device 605 may be implemented as a single apparatus, system, or device or may be implemented in a distributed manner as multiple apparatuses, systems, or devices. Computing device 605 includes, but is not limited to, processing system 625, storage system 610, software 615, communication interface system 620, and user interface system 630. Processing system 625 is operatively coupled with storage system 610, communication interface system 620, and user interface system 630.

Processing system 625 loads and executes software 615 from storage system 610. Software 615 includes and implements storage operating system 635, which is representative of the processes discussed with respect to the preceding Figures. When executed by processing system 625, software 615 directs processing system 625 to operate as described herein for at least the various processes, operational scenarios, and sequences discussed in the foregoing implementations. Computing device 605 may optionally include additional devices, features, or functionality not discussed for purposes of brevity.

Referring still to FIG. 6, processing system 625 may include a micro-processor and other circuitry that retrieves and executes software 615 from storage system 610. Processing system 625 may be implemented within a single processing device but may also be distributed across multiple processing devices or sub-systems that cooperate in executing program instructions. Examples of processing system 625 include general purpose central processing units, microcontroller units, graphical processing units, application specific processors, integrated circuits, application specific integrated circuits, and logic devices, as well as any other type of processing device, combinations, or variations thereof.

Storage system 610 may comprise any computer readable storage media readable by processing system 625 and capable of storing software 615. Storage system 610 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 610 may be implemented as a single storage device but may also be implemented across multiple storage devices or sub-systems co-located or distributed relative to each other. Storage system 610 may comprise additional elements, such as a controller, capable of communicating with processing system 625 or possibly other systems.

Software 615 (including storage operating system 635) may be implemented in program instructions and among other functions may, when executed by processing system 625, direct processing system 625 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 615 may include additional processes, programs, or components, such as operating system software, virtualization software, or other application software. Software 615 may also comprise firmware or some other form of machine-readable processing instructions executable by processing system 625.

In general, software 615, when loaded into processing system 625 and executed, transforms a suitable apparatus, system, or device (of which computing device 605 is representative) overall from a general-purpose computing system into a special-purpose computing system customized to support storage processes as described herein. Indeed, encoding software 615 on storage system 610 may transform the physical structure of storage system 610. The specific transformation of the physical structure may depend on various factors in different implementations of this description. Examples of such factors may include, but are not limited to, the technology used to implement the storage media of storage system 610 and whether the computer-storage media are characterized as primary or secondary storage, as well as other factors.

For example, if the computer readable storage media are implemented as semiconductor-based memory, software 615 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 620 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 605 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 114(f) will begin with the words “means for”, but use of the term “for” in any other context is not intended to invoke treatment under 35 U.S.C. § 114(f). Accordingly, the applicant reserves the right to pursue additional claims after filing this application to pursue such additional claim forms, in either this application or in a continuing application.

What is claimed is:

1. A method of operating multiple storage controllers in a data storage environment, the method comprising:
by data element of a storage controller of the multiple storage controllers:
receiving an input/output request from a network element of a one of the multiple storage controllers corresponding to data of a multi-part file stored across multiple storage devices in the data storage environment, wherein the input/output request includes current attributes of the multi-part file;
executing the input/output request with respect to a part of the multi-part file corresponding to the storage controller; and
determining whether to delegate attribute authority to the network element based on a set of criteria.

2. The method of claim 1, further comprising, by the data element of the storage controller:
responsive to determining to delegate the attribute authority to the network element, delegating the attribute authority to the network element;
updating the current attributes of the multi-part file to reflect the input/output request, resulting in updated attributes; and
returning the updated attributes to the network element.

3. The method of claim 2, further comprising, by the data element of the storage controller:
receiving a write request from the network element of the one of the multiple storage controllers to write data to the multi-part file, wherein the write request includes the updated attributes of the multi-part file;
executing the write request with respect to the part of the multi-part file corresponding to the storage controller; and
responsive to determining that the network element has the attribute authority:
updating the updated attributes of the multi-part file to reflect the write request, resulting in newly updated attributes; and
returning the newly updated attributes to the network element.

4. The method of claim 2, wherein delegating the attribute authority to the network element comprises, by the data element of the storage controller, updating metadata of a storage controller of the multiple storage controllers to reflect that attributes of the multi-part file, including the current attributes, are locked for editing by the network element and are unavailable for editing by other network elements of other ones of the multiple storage controllers.

5. The method of claim 1, further comprising, by the data element of the storage controller:
responsive to determining to not delegate the attribute authority to the network element, obtaining new attributes of the multi-part file;
updating the new attributes of the multi-part file to reflect the input/output request, resulting in new updated attributes; and
returning the new updated attributes to the network element.

6. The method of claim 1, wherein the set of criteria comprises input/output activity relative to threshold input/output activity of the network element of the one of the multiple storage controllers.

7. The method of claim 1, wherein the current attributes comprise timestamps and lengths of at least the part of the multi-part file.

8. The method of claim 1, wherein the one of the multiple storage controllers comprises the storage controller or a different one of the multiple storage controllers.

9. The method of claim 1, wherein the network element comprises a network element of the storage controller of the multiple storage controllers or a network element of a different storage controller of the multiple storage controllers.

10. One or more non-transitory computer-readable storage media having stored thereon program instructions executable by a data element of a storage controller in a data storage environment, that, when executed by one or more processors, direct the data element to:
receive an input/output request from a network element of a one of multiple storage controllers in the data storage environment corresponding to data of a multi-part file stored across multiple storage devices in the data storage environment, wherein the input/output request includes current attributes of the multi-part file;
execute the input/output request with respect to a part of the multi-part file corresponding to the storage controller; and
determine whether to delegate attribute authority to the network element based on a set of criteria.

11. The one or more non-transitory computer-readable storage media of claim 10, wherein the program instructions further direct the data element to:
responsive to determining to delegate the attribute authority to the network element, delegate the attribute authority to the network element;
update the current attributes of the multi-part file to reflect the input/output request, resulting in updated attributes; and
return the updated attributes to the network element.

12. The one or more non-transitory computer-readable storage media of claim 11, wherein the program instructions further direct the data element to:
receive a write request from the network element of the one of the multiple storage controllers to write data to the multi-part file, wherein the write request includes the updated attributes of the multi-part file;
execute the write request with respect to the part of the multi-part file corresponding to the storage controller; and
responsive to determining that the network element has the attribute authority:
update the updated attributes of the multi-part file to reflect the write request, resulting in newly updated attributes; and
return the newly updated attributes to the network element.

13. The one or more non-transitory computer-readable storage media of claim 11, wherein to delegate the attribute authority to the network element, the program instructions direct the data element to update metadata of a storage controller of the multiple storage controllers to reflect that attributes of the multi-part file, including the current attributes, are locked for editing by the network element and are unavailable for editing by other network elements of other ones of the multiple storage controllers.

14. The one or more non-transitory computer-readable storage media of claim 10, wherein the program instructions further direct the data element to:
responsive to determining to not delegate the attribute authority to the network element, obtain new attributes of the multi-part file;
update the new attributes of the multi-part file to reflect the input/output request, resulting in new updated attributes; and
return the new updated attributes to the network element.

15. The one or more non-transitory computer-readable storage media of claim 10, wherein the set of criteria comprises input/output activity relative to threshold input/output activity of the network element of the one of the multiple storage controllers.

16. The one or more non-transitory computer-readable storage media of claim 10, wherein:
the current attributes comprise timestamps and lengths of at least the part of the multi-part file;
the one of the multiple storage controllers comprises the storage controller or a different one of the multiple storage controllers; and
the network element comprises a network element of the storage controller of the multiple storage controllers or a network element of a different storage controller of the multiple storage controllers.

17. A computing apparatus comprising:
one or more computer-readable storage media; and
program instructions stored on the one or more computer-readable storage media executable by a processing device that, based on being read and executed by the processing device, direct the processing device to:
receive an input/output request from a network element of a one of multiple storage controllers in a data storage environment corresponding to data of a multi-part file stored across multiple storage devices in the data storage environment, wherein the input/output request includes current attributes of the multi-part file;
execute the input/output request with respect to a part of the multi-part file corresponding to the storage controller; and
determine whether to delegate attribute authority to the network element based on a set of criteria.

18. The computing apparatus of claim 17, wherein the program instructions further direct the processing device to:
responsive to determining to delegate the attribute authority to the network element, delegate the attribute authority to the network element;
update the current attributes of the multi-part file to reflect the input/output request, resulting in updated attributes; and
return the updated attributes to the network element.

19. The computing apparatus of claim 17, wherein the program instructions further direct the data element to:
responsive to determining to not delegate the attribute authority to the network element, obtain new attributes of the multi-part file;
update the new attributes of the multi-part file to reflect the input/output request, resulting in new updated attributes; and
return the new updated attributes to the network element.

20. The computing apparatus of claim 17, wherein the set of criteria comprises input/output activity relative to threshold input/output activity of the network element of the one of the multiple storage controllers.
